(19) United States
(12) Patent Application Publication
(10) Pub. No.: US 2018/0097807 A1
(43) Pub. Date: Apr. 5, 2018

(54) METHOD AND APPARATUS FOR PERFORMING INITIAL ACCESS PROCEDURE BASED ON AUTHENTICATION IN WIRELESS COMMUNICATION SYSTEM

(71) Applicant: LG ELECTRONICS INC., Seoul (KR)

(72) Inventors: Genebeck HAHN, Seoul (KR); Jiwon KANG, Seoul (KR); Heejin KIM, Seoul (KR); Ilmu BYUN, Seoul (KR); Heejeong CHO, Seoul (KR)

(73) Assignee: LG ELECTRONICS INC., Seoul (KR)

(21) Appl. No.: 15/672,191

(22) Filed: Aug. 8, 2017

Related U.S. Application Data
(60) Provisional application No. 62/401,915, filed on Sep. 30, 2016.

(51) Int. Cl. H04L 29/06

(52) U.S. Cl. CPC H04L 63/0876; H04L 63/123; H04L 63/061

(57) ABSTRACT

In the present invention, a method and an apparatus for performing initial access procedure based on authentication in a wireless communication system are disclosed. The method may comprise generating a pseudo permanent identifier based on a permanent identifier of the user equipment, transmitting, to a first authentication entity, a first message including the pseudo permanent identifier and an index of a specification authentication key, receiving, from the first authentication entity, a second message including a first MAC for at least one a first new authentication key generated by a second authentication entity or a first increased counter at the second authentication entity for a specific authentication counter, and transmitting, to the first authentication entity, a third message including a second MAC for at least one a second new authentication key generated by the user equipment or a second increased counter at the user equipment for the specific authentication counter.

### CROSS-REFERENCE TO RELATED APPLICATIONS

Pursuant to 35 U.S.C. § 119(e), this application claims the benefit of U.S. Provisional Patent Application No. 62/401,915, filed on Sep. 30, 2016, the contents of which are hereby incorporated by reference herein in its entirety.

### BACKGROUND OF THE INVENTION

### Field of the Invention

The present invention relates to wireless communication systems, and more particularly, to a method for performing an initial access procedure based on authentication and an apparatus for supporting the same.

### Discussion of the Related Art

The mobile communication system is developed to provide the voice service while guaranteeing the activity of a user. However, the mobile communication system is extended to the data service in addition to the voice service. Currently, since the shortage of resource is caused owing to the explosive traffic increase and users requires higher services, more developed mobile communication system is needed.

The requirement for the next mobile communication system should support the acceptance of explosive data traffic increase, the innovative increase of transmission rate per user, the acceptance of the number of connection devices which are dramatically increased, very low End-to-End Latency, high energy efficiency. To this end, various techniques have been researched such as the Dual Connectivity, the Massive Multiple Input Multiple Output (Massive MIMO), the In-band Full Duplex, the Non-Orthogonal Multiple Access (NOMA), the Super wideband support, the Device Networking, and so on.

### SUMMARY OF THE INVENTION

The present invention proposes a method for performing an initial access to a network using Pseudo International Mobile Subscriber Identity (IMSI) in a wireless communication system.

In addition, the present invention proposes a method for preventing an IMSI of a user equipment from being exposed through information (e.g., Kᵢ, Kᵢ_{_}index and Kᵢ_{_}index_Counter) shared between the user equipment and a Home Subscriber Server (HSS).

In addition, the present invention proposes a method for preventing an IMSI of a user equipment from being exposed using a Message Authentication Code (MAC) value for New Kᵢ_{_}index or increased Kᵢ_{_}index_Counter between the user equipment and an Authentication, Authorization and Accounting (AAA).

In addition, the present invention proposes a method for generating a MAC value for the New Kᵢ_{_}index or increased Kᵢ_{_}index_Counter using an authentication key (e.g., Message Authentication Key (MAK)).

The technical objects to attain in the present invention are not limited to the above-described technical objects and other technical objects which are not described herein will become apparent to those skilled in the art from the following description.

According to an embodiment of the present disclosure, a method for performing initial access procedure based on authentication in a wireless communication system, the method performed by a user equipment comprises generating a pseudo permanent identifier based on a permanent identifier of the user equipment; transmitting, to a first authentication entity, a first message including the pseudo permanent identifier and an index of a specification authentication key; receiving, from the first authentication entity, a second message including a first Message Authentication Code (MAC) for at least one a first new authentication key generated by a second authentication entity or a first increased counter at the second authentication entity for a specific authentication counter; and in response to the first MAC, transmitting, to the first authentication entity, a third message including a second MAC for at least one a second new authentication key generated by the user equipment or a second increased counter at the user equipment for the specific authentication counter; wherein the specification authentication key and the specific authentication counter are predefined between the user equipment and the second authentication entity.

In addition, the first new authentication key may be generated by using the first increased counter and the specification authentication key that is identified based on the pseudo permanent identifier; and the second new authentication key may be generated by using the second increased counter and the specification authentication key.

In addition, the specific authentication counter of the second authentication entity may be increased by generating the first new authentication key; and the specific authentication of the user equipment may be increased by generating the pseudo permanent identifier.

In addition, the first MAC and the second MAC may be generated by using an authentication key, and the authentication key may be based on at least one the specific authentication key or a random value generated by the second authentication entity.

In addition, the random value may be generated by using an authentication vector.

In addition, the second message may further include an indication for increasing the specific authentication counter of the user equipment.

In addition, the third message may further include an indication for representing increase of the specific authentication counter of the user equipment.

In addition, the method may further comprise prior to transmitting the third message, in response to the received second message, calculating the second MAC based on the second increased counter and the second new authentication key; and determining whether a value for the received first MAC is identical to a value for the calculated second MAC.

According to another embodiment of the present disclosure, a user equipment for performing initial access procedure based on authentication in a wireless communication system, the user equipment comprises a transmission/reception unit for transmitting and receiving a radio signal, and a processor functionally coupled to the transmission/reception unit, wherein the processor is configured to control to generate a pseudo permanent identifier based on a permanent identifier of the user equipment; transmit, to a first authentication entity, a first message including the pseudo permanent identifier and an index of a specification authentication key; receive, from the first authentication entity, a second message including a first Message Authentication Code (MAC) for at least one a first new authentication key generated by a second authentication entity or a first increased counter at the second authentication entity for a specific authentication counter; and in response to the first MAC, transmit, to the first authentication entity, a third message including a second MAC for at least one a second new authentication key generated by the user equipment or a second increased counter at the user equipment for the specific authentication counter; wherein the specification authentication key and the specific authentication counter are predefined between the user equipment and the second authentication entity.

### BRIEF DESCRIPTION OF THE DRAWINGS

The accompanying drawings, which are included herein as a part of the description for help understanding the present invention, provide embodiments of the present invention, and describe the technical features of the present invention with the description below.

FIG. 1 illustrates a diagram of an example of a Roaming Security Architecture for a network access.

FIG. 2 illustrates an example of an authentication data exchange procedure between an MME and an HSS for authenticating a UE.

FIG. 3 illustrates an example of an initial access procedure of a UE.

FIG. 4 illustrates an example of a procedure for an RRC connection for an initial access and an Attach Request message transfer of a UE.

FIG. 5 illustrates an example of a network access procedure of a UE using a Pseudo IMSI.

FIG. 6 illustrates an example of an initial access procedure of a UE using a Pseudo IMSI to which the present invention may be applied.

FIG. 7 illustrates another example of an initial access procedure of a UE using a Pseudo IMSI to which the present invention may be applied.

FIG. 8 illustrates a block diagram of a wireless communication apparatus according to an embodiment of the present invention.

### DETAILED DESCRIPTION OF THE INVENTION

Hereafter, preferred embodiments of the present invention will be described in detail with reference to the accompanying drawings. A detailed description to be disclosed hereinbelow together with the accompanying drawing is to describe embodiments of the present invention and not to describe a unique embodiment for carrying out the present invention. The detailed description below includes details in order to provide a complete understanding. However, those skilled in the art know that the present invention can be carried out without the details.

In some cases, in order to prevent a concept of the present invention from being ambiguous, known structures and devices may be omitted or may be illustrated in a block diagram format based on core function of each structure and device.

In the specification, a base station means a terminal node of a network directly performing communication with a terminal. In the present document, specific operations described to be performed by the base station may be performed by an upper node of the base station in some cases. That is, it is apparent that in the network constituted by multiple network nodes including the base station, various operations performed for communication with the terminal may be performed by the base station or other network nodes other than the base station. A base station (BS) may be generally substituted with terms such as a fixed station, Node B, evolved-NodeB (eNB), a base transceiver system (BTS), an access point (AP), and the like. Further, a ‘terminal’ may be fixed or movable and be substituted with terms such as user equipment (UE), a mobile station (MS), a user terminal (UT), a mobile subscriber station (MSS), a subscriber station (SS), an dvanced mobile station (AMS), a wireless terminal (WT), a Machine-Type Communication (MTC) device, a Machine-to-Machine (M2M) device, a Device-to-Device (D2D) device, and the like.

Hereinafter, a downlink means communication from the base station to the terminal and an uplink means communication from the terminal to the base station. In the downlink, a transmitter may be a part of the base station and a receiver may be a part of the terminal. In the uplink, the transmitter may be a part of the terminal and the receiver may be a part of the base station.

Specific terms used in the following description are provided to help appreciating the present invention and the use of the specific terms may be modified into other forms within the scope without departing from the technical spirit of the present invention.

The following technology may be used in various wireless access systems, such as code division multiple access (CDMA), frequency division multiple access (FDMA), time division multiple access (TDMA), orthogonal frequency division multiple access (OFDMA), single carrier-FDMA (SC-FDMA), non-orthogonal multiple access (NOMA), and the like. The CDMA may be implemented by radio technology universal terrestrial radio access (UTRA) or CDMA2000. The TDMA may be implemented by radio technology such as Global System for Mobile communications (GSM)/General Packet Radio Service(GPRS)/Enhanced Data Rates for GSM Evolution (EDGE). The OFDMA may be implemented as radio technology such as IEEE 802.11(Wi-Fi), IEEE 802.16(WiMAX), IEEE 802-20, E-UTRA(Evolved UTRA), and the like. The UTRA is a part of a universal mobile telecommunication system (UMTS). 3rd generation partnership project (3GPP) long term evolution (LTE) as a part of an evolved UMTS (E-UMTS) using evolved-UMTS terrestrial radio access (E-UTRA) adopts the OFDMA in a downlink and the SC-FDMA in an uplink. LTE-advanced (A) is an evolution of the 3GPP LTE.

The embodiments of the present invention may be based on standard documents disclosed in at least one of IEEE 802, 3GPP, and 3GPP2 which are the wireless access systems. That is, steps or parts which are not described to definitely show the technical spirit of the present invention among the embodiments of the present invention may be based on the documents. Further, all terms disclosed in the document may be described by the standard document.

3GPP LTE/LTE-A is primarily described for clear description, but technical features of the present invention are not limited thereto.

Location information means a series of information that may represent locations of individuals during a specific time. In the future, since a plurality of users is able to be provided with various services based on their own location information through smart phones in 5G (Generation) mobile communication environment, the location information of a user is recognized as very sensitive information. Up to now, the privacy issue for the location information of a user of mobile communication has not been dealt seriously in LTE/LTE-A standard progressed by 3GPP standardization organization.

The user authentication scheme adopted in LTE/LTE-A standard is in succession to the authentication scheme based on the International Mobile Subscriber Identity (IMSI) of a user defined in the Global System for Mobile Communications (GSM) of 2G and the Universal Mobile Telecommunication System (UMTS) of 3G. Accordingly, the user authentication scheme adopted in LTE/LTE-A standard has the weak points on the protocol of 2G/3G as it is. Here, one of the weak points is the problem for the IMIS privacy transferred without any protection through an Air Interface.

In the GSM system of 2G or the UMTS system of 3G, the researches for providing privacy protection for a user identifier (i.e., IMSI) have been progressed, but the researches do not propose a solution for the privacy issue through a Radio Interface. 4G system uses a temporary identifier (e.g., Globally Unique Temporary Identifier (GUTI)) for satisfying the requirement for location privacy. Herein, the temporary identifier may be used after the authentication for a user is successfully completed.

The GUTI becomes a means for identifying the home network of a user accessing to a serving network. That is, in the case that a serving network does not have a certain valid credential for a user, the serving network should verify an identifier of the user before permitting a specific service to the corresponding user. The verification is performed when the serving network requests an IMSI of the corresponding user to the home network. In the case that authentication is successfully completed after the serving obtains the authentication information for the user through the IMSI received from the home network, a GUTI is transferred to the corresponding user. Herein, the GUTI is configured using a Globally Unique MME Identifier (GUMMEI) and an MME-Temporary Mobile Subscriber Identity (M-TMSI), and a user is identified by the M-TMSI (32 bits) in an MME.

LTE/LTE-A system may be classified into a Radio Access Network (RAN) and a Core Network (CN), largely. Herein, the RAN takes charge of all features in relation to a Radio Interface, and takes charge of a point of entry into a network for terminals. That is, the RAN provides encryption and integrity protection for all user data and signaling traffic transferred through Over The Air (OTA). On the other hand, the CN stores the subscriber information of users, and provides functions such as a terminal authentication of a user and a security key configuration through it.

LTE/LTE-A provides a service level and a data rate far better than those of 2G/3G network. In addition, through LTE-A, the radio network structure is evolving in such a form that a various shapes of Small Cells (Pico, Femto, etc.) is associated with a Macro Cell. The evolution is objected to increase Quality of Experience (QoE) by providing higher data date to a final user in a situation in which multi-layer cells of vertical layers involved with a macro cell are coexisted.

Considering the trend described above, in 5G wireless communication (i.e., mobile communication) environment, as the majority of small cells are accommodated, it is anticipated that final users are located physically more closely in a network. In this case, since the user-oriented connectivity is increased significantly (i.e., Hyper Connectivity), the importance of a location information privacy of a user will become greater.

As described above, the privacy issue for an identifier of a user is very important security issue for mobile communication users. The information of a permanent identifier (e.g., IMSI) may enable malicious attackers to obtain huge information of users. The fact that the malicious attackers may obtain huge information of users may lead to various dangers unexpected, and means that there is significant problem when using services such as online banking, shopping, and so on through a terminal.

For example, in the case that a user (or terminal) accesses a plurality of network slices simultaneously through 5G mobile communication system, when the same identifier is used for all slices, the attacker that obtains the corresponding identifier maliciously may access to the network slices as if the attacker is a user using the obtained identifier. Through this, the attacker may obtain information such as the service that the user is subscribed, the location where the user uses a service, and so on.

LTE/LTE-A is a mobile communication system proposed by 3GPP, and provides a level of security which is more improved than the previous mobile communication systems (e.g., GSM and UMTS).

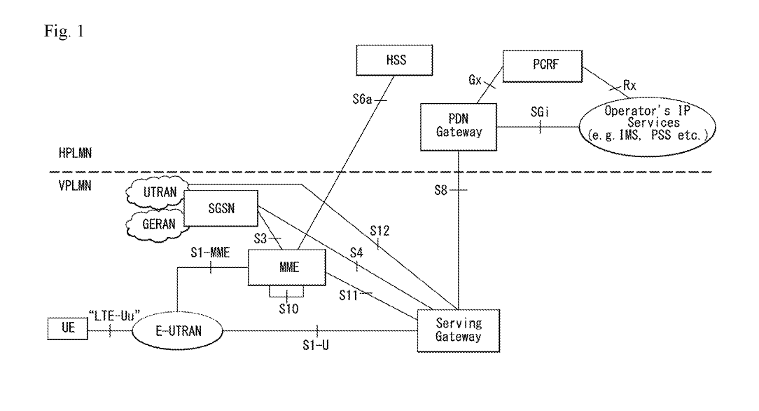

FIG. 1 illustrates a diagram of an example of a Roaming Security Architecture for a network access. FIG. 1 is only shown for the convenience of description, but does not limit the scope of the present invention.

Referring to FIG. 1, each of user equipments (UEs) (user or terminal) is registered in a Home Public Land Mobile Network (HPLMN) using its own subscriber/profile information stored in a Home Subscriber Server (HSS). In a Visited Public Land Mobile Network (VPLMN), a UE is connected to a BS through a Uu interface for Attach, Tracking Area Update (TAU), and/or Service Request.

In FIG. 1, an MME is a core control node for LTE access network, and plays the role of authenticating a UE with being interlocked with the HSS. Here, the MME may obtain the authentication data for the UE with being interlocked with the HSS.

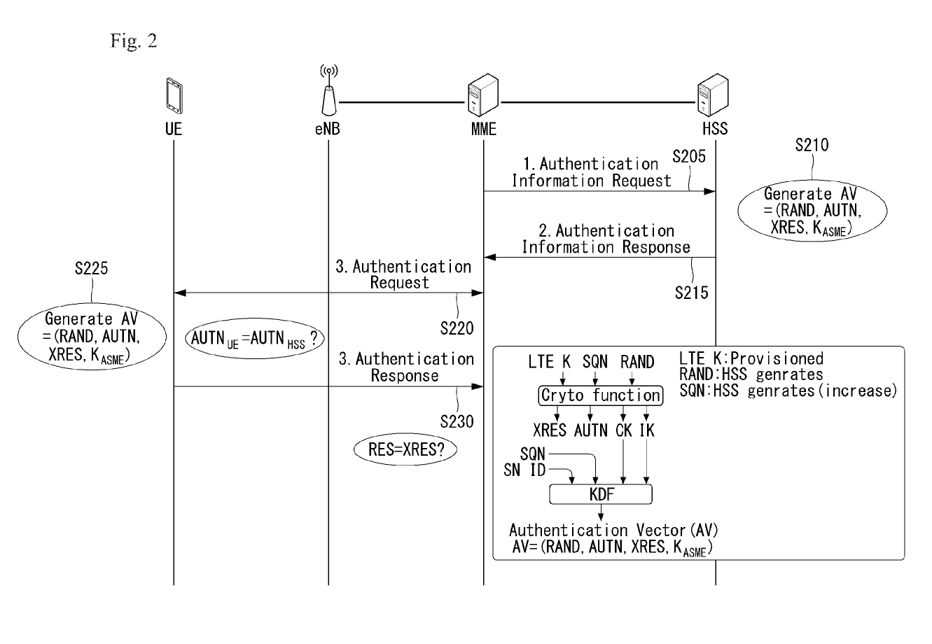

FIG. 2 illustrates an example of an authentication data exchange procedure between an MME and an HSS for authenticating a UE. FIG. 2 is only shown for the convenience of description, but does not limit the scope of the present invention.

Referring to FIG. 2, an Evolved Packet System-Authentication and Key Agreement (EPS-AKA) is an authentication and key agreement procedure. Through the EPS-AKA, the key materials for extracting User plane (UP)/Radio Resource Control (RRC)/Non-Access Stratum (NAS) encryption key and RRC/NAS integrity key.

The EPS-AKA procedure is performed when a UE tries to perform an initial access to a network, basically.

Referring to FIG. 2, in step S205, a MME transmits Authentication Information Request message to a HSS. The Authentication Information Request message comprises IMSI, SN ID (MCC+MNC), etc.

In step S210, the HSS generates Authentication Vector (AV). The AV comprises RAND, AUTN, XRES, K_{ASME}. In here, The K_{ASME} is top-level security key in Access zone and used to generate NAS security key between a UE and the MME.

In step S215, the HSS transmits Authentication Information Response message to the MME. The Authentication Information Response message comprises AV.

In step S220, the MME transmits Authentication Request message to the UE. The Authentication Request message comprises RAND, AUTN, KIS_{ASME}.

In step S225, the UE generates AV. The AV comprises RAND, AUTN, XRES, K_{ASME}. In here, The K_{ASME} is top-level security key in Access zone and used to generate NAS security key between a UE and the MME.

In step S230, the UE transmits Authentication Response message to the MME.

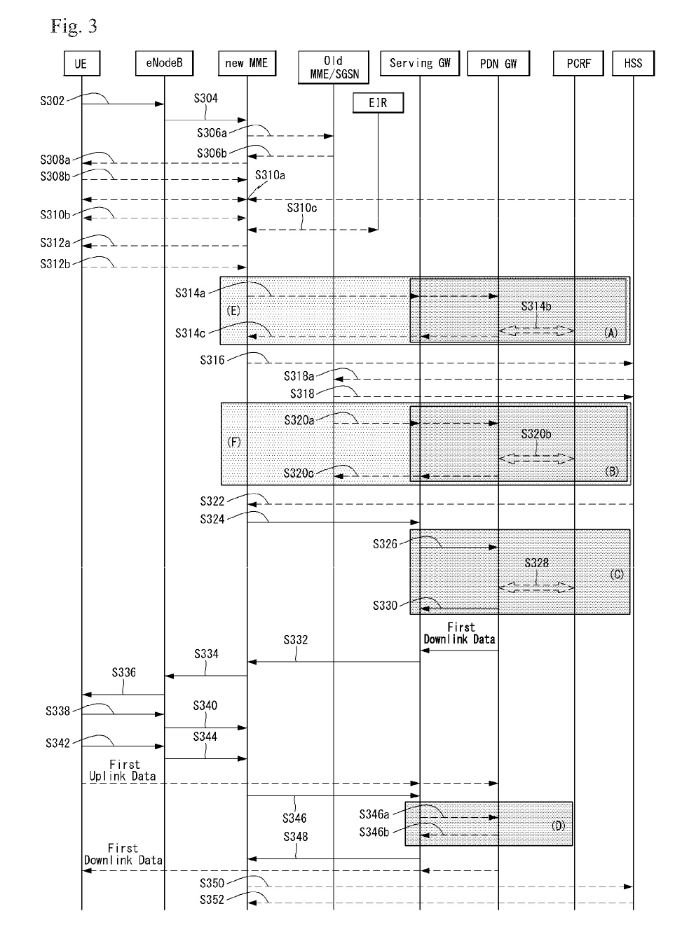

FIG. 3 illustrates an example of an initial access procedure of a UE. FIG. 3 is only shown for the convenience of description, but does not limit the scope of the present invention.

Referring to FIG. 3, in step S302, a UE transmits Attach Request message to an eNodeB and in step S304, the eNodeB transmits Attach Request message to a new MME.

The new MME transmits Identification Request message to Old MME/SGSN in step S306a, and receives Identification Response message from the Old MME/SGSN in step S306b.

The new MME transmits Identity Request message to the UE in step S308a and receives Identity Response message from the UE in step S308b.

In step S310a, Authentication and/or Security operation is performed between the UE, the new MME, and a HSS. In step S310b, the UE exchanges Identity Request message and Identity Response message with the new MME. In step S310b, the new MME and an EIR perform ME Identity check.

In step S312a, the UE receives Ciphered Options Request message from the new MME and transmits Ciphered Options Response message to the new MME.

In step S314a, the new MME transmits Delete Session Request message to a PDN GW, through a Serving GW. In step S314b, PCEF Initiated IP-CAN Session Termination procedure is performed between the PDN GW and PCRF. In step S314c, the PDN GW transmits Delete Session Response message to the new MME, through a Serving GW.

In step S316, the new MME transmits Update Location Request message to the HSS. After, the HSS transmits Cancel Location Request message to the Old MME/SGSN in step S318a and receives Cancel Location ACK message from the Old MME/SGSN in step S318.

In step S320a, the Old MME/SGSN transmits Delete Session Request message to a PDN GW, through a Serving GW. In step S320b, PCEF Initiated IP-CAN Session Termination procedure is performed between the PDN GW and PCRF. In step S320c, the PDN GW transmits Delete Session Response message to the Old MME/SGSN, through a Serving GW.

In step S322, the HSS transmits Update Location ACK message to the new MME. In step S324, the new MME transmits Create Session Request message to the Serving GW.

In step S326, the Serving GW transmits Create Session Request message to the PDN GW. In step S328, PCEF Initiated IP-CAN Session Establishment/Modification procedure is performed between the PDN GW and PCRF. In step S330, the PDN GW transmits Create Session Response message to the Serving GW.

After, (if not handover) the PDN GW transmits First Downlink Data to the Serving GW.

In step S332, the new MME receives Create Session Response message from the Serving GW.

In step S334, the eNodeB receives Initial Context Setup Request message and/or Attach Accept message from the new MME. After, the eNodeB transmits RRC Connection Reconfiguration message to the UE in step S336 and receives RRC Connection Reconfiguration Complete message from the UE in step S338.

In step S340, the eNodeB transmits Initial Context Setup Response message to the new MME.

The UE transmits direct transfer to the eNodeB in step S342 and the eNodeB transmits Attach Complete message to the new MME.

After, the UE transmits First Uplink Data to the PDN GW through the Serving GW.

In step S346, the new MME transmits Modify Bearer Request to the Serving GW. In this case, the Serving GW transmits Modify Bearer Request message to the PDN GW and receives Modify Bearer Response message from the PDN GW. In step S348, the new MME receives Modify Bearer Response message from the Serving GW.

After, the PDN GW transmits First Downlink Data to the UE through the Serving GW.

In step S350, the new MME transmits Notify Request message to the HSS, and in step S352, the new MME receives Notify Response message from the HSS.

As described above, a UE should perform an Attach procedure for performing an initial authentication. In this case, in the Attach Request message transferred to an MME through an RRC signaling from a UE, a permanent identifier (IMSI) of the UE is included without any protection. The reason why the permanent identifier of the UE is included without any protection in the Attach Request message is because the UE does not have a temporary identifier when performing an initial access.

In the aspect of a network, when the authentication for a UE is successfully completed while any entity does not have the context for the corresponding UE, an MME generate a new temporary identifier (i.e., GUTI), and allocates the new temporary identifier to the UE through NAS. In this case, since the GUTI is forwarded after the authentication procedure for the UE is successfully completed and the NAS security is activated, the GUTI may be forwarded to the UE safely. After the new GUTI is allocated to the UE, the MME manages the mapping information between the IMSI and the GUTI allocated to the UE.

Here, the object of allocating the GUTI to the UE is for the MME able to identify the corresponding UE without exposing the permanent identifier (i.e., IMSI) of the UE to the OTA after allocating the GUTI. That is, the identification of the UE for all connection configurations (e.g., Attach Request, TAU and Service Request) through a radio path after the initial access is performed using the GUTI, not the IMSI.

In order to guarantee the privacy for the permanent identifier (i.e., IMSI) of the UE, the confidentiality of the IMSI should be protected. In other words, the IMSI should not be transmitted through the OTA in the form of a clear-text (i.e., information without any protection). When the IMSI is exposed, a malicious attacker may obtain the information such as a movement pattern of the corresponding user, and the like.

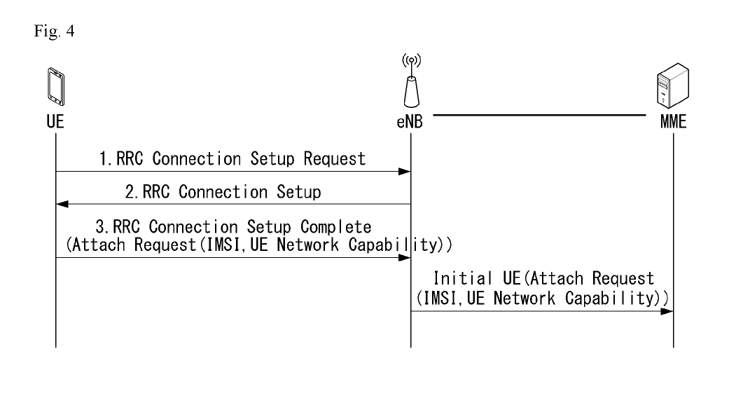

FIG. 4 illustrates an example of a procedure for an RRC connection for an initial access and an Attach Request message transfer of a UE. FIG. 4 is only shown for the convenience of description, but does not limit the scope of the present invention.

Referring to FIG. 4, for an initial access, a UE transmits an RRC Connection Setup Request message to an eNB. When the UE receives an RRC connection Setup message in response to the message from the eNB, the UE transmits an RRC Connection Setup Complete message to the eNB. Here, the RRC Connection Setup Complete message indicates that the RRC connection Setup is completed, and includes an IMSI (IMSI without any protection) of the UE and Network Capability information of the UE. Later, the eNB transmits an Attach Request message including the IMSI (IMSI without any protection) of the UE to an MME, for an initial access of the UE.

LTE/LTE-A system accommodates the Security Arrangement like a GUTI that may be used instead of an IMSI. However, in the following cases, the IMSI, instead of the GUTI, may be transmitted through the OTA.

(1) As shown in FIG. 4, the case that an Attach Procedure for an initial network access of a UE is performed.

(2) Through a Radio Path, the case that a serving network is unable to deduct an IMSI using the GUTI used for a UE for identifying the UE itself

(3) The case that, after a UE moves to an area of a new MME, the new MME is unable to obtain an IMSI from the previous MME.

(4) The case that signals of a normal BS requests an IMSI to a UE as the signals are drowned by a signal of a fake BS.

Since the cases described above are existed, it is required to consider a method for dealing with the situation in which an IMSI may be exposed in LTE/LTE-A system. As for the method, a method may be considered for a UE to generate a Pseudo IMSI (i.e., Pseudo permanent identifier), and to use the generated Pseudo IMSI, thereby the IMSI not being exposed.

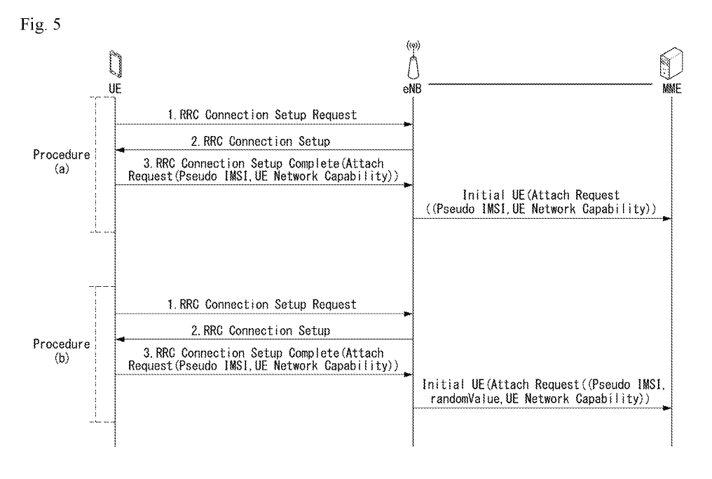

FIG. 5 illustrates an example of a network access procedure of a UE using a Pseudo IMSI. FIG. 5 is only shown for the convenience of description, but does not limit the scope of the present invention.

Referring to FIG. 5, a UE performs an RRC Connection Setup procedure with a BS using a Pseudo IMSI, and the BS performs a procedure for forwarding the Pseudo IMSI to an MME for identifying the UE.

In this case, the Pseudo IMSI may be generated based on an IMSI and a Master Key Kᵢ possessed by the UE. Or, the Pseudo IMSI may be generated based on a randomvalue generated by the UE additionally, as well as the IMSI and the Master Key Kᵢ possessed by the UE. Here, the IMSI is a value having maximum 15 bit length, and includes PLMN ID (MSS (3 bit)+MNC (2-3 bit))+MSIN (9-10 bit). In addition, Long Term Shared Key K (e.g., Kᵢ) is a Master Key having 128 bit length. Furthermore, the randomvalue may be a value of 40 bit length used for the identification use for the UE instead of S-TMSI (SAE-Temporary Mobile Subscriber Identity) (40 bit) in an RRC Connection Setup Request message, before a GUTI is allocated.

When the Pseudo IMSI is generated using the IMSI and the Master Key, the UE may perform a network access procedure according to Procedure (a) shown in FIG. 5. Different from it, when the Pseudo IMSI is generated using the IMSI, the Master Key Kᵢ and the randomvalue, the UE may perform a network access procedure according to Procedure (b) shown in FIG. 5.

In addition, in this case, in order for an HSS able to obtain the IMSI using the Pseudo IMSI transmitted from the UE, the HSS should be able to know how the corresponding UE generates the Pseudo IMSI and which Kᵢ is used for generating it. For this, as another value possessed only between the UE and the HSS, an index (Kᵢ_{_}index) is used for the Master Key Kᵢ for each UE. That is, when the MME receives the Pseudo IMSI from the UE through a NAS message (e.g., Attach Request, etc.) and transfers the Pseudo IMSI to the HSS, in order for the HSS to determine which Long Term Shared Key is connected with the IMSI hidden by the Pseudo IMSI, the UE and the HSS may maintain a unique Key index (e.g., Kᵢ_{_}index) with respect to a specific Master Key Kᵢ. Through the Key index, the HSS may identify Kᵢ in relation to the Pseudo IMSI.

More particularly, when the UE transfers the NAS message through an RRC message, the UE transfers the NAS message with the Pseudo IMSI and the Kᵢ_{_}index being included to the MME, and the MME transfers the Pseudo IMSI and the Kᵢ_{_}index to the HSS. Later, the HSS may determine which Master Key K should be used for extracting the IMSI from the received Pseudo IMSI using the received Kᵢ_{_}index. Then, the HSS may recover the permanent identifier of a specific UE, that is, the IMSI from the Pseudo IMSI using the identified Master Key K.

As described above, in the case of the method for performing an initial access to a network using the Pseudo IMSI, since the IMSI, the Kᵢ, and the Kᵢ_{_}index are possessed only by the UE and the HSS, it may be prevented that the IMSI is exposed through the information shared between the UE and the HSS.

However, in the network initial access method using the Pseudo IMSI described above, as the UE accesses using the same Kᵢ_{_}index whenever the UE accesses to the network or when the UE frequently accesses to the network, the Kᵢ_{_}index exposed maliciously may provide the fact that the same user accesses the network although it is unable to know who the user is. In this case, when a malicious attacker that obtains the Kᵢ_{_}index and the Pseudo IMSI transmits the Kᵢ_{_}index and the Pseudo IMSI to the network, the malicious attacker may receive authentication as if the malicious attacker is a normal user.

Accordingly, the present invention provides a method for solving the problem of the network initial access method using the Pseudo IMSI described above, by placing emphasis on providing privacy which is driven by a user for a permanent identifier of a UE, that is, an IMSI.

Through the method proposed in the present invention, a UE may perform an authentication procedure without exposing its own identifier when performing an initial network access. Particularly, a UE may remove the connectivity between a specific Pseudo IMSI and a specific index (i.e., specific Kᵢ_{_}index) using different index (i.e., different Kᵢ_{_}index) whenever the UE uses the Pseudo IMSI.

Herein, removal of the connectivity between a specific Pseudo IMSI and a specific index may mean that a UE removes the security problems that may occur when the UE performs the procedure like Attach continually using the same index which is not changed for the specific Pseudo IMSI.

The present invention proposes a method for solving the problem that a permanent identifier (i.e., IMSI) of a UE is transmitted to an OTA without any protection in 5G wireless communication environment. For this, in the method proposed, the IMSI, the Kᵢ, the Kᵢ_{_}index, and the like are assumed to be the information maintained only between a Universal Subscriber Identity Module (USIM) of the UE and an HSS, and through the information, the privacy for an end-to-end identifier for the UE may be protected.

Different from the method described above, a method proposed in the present invention may use the Kᵢ_{_}index which is changed whenever using the Pseudo IMSI in order to remove the connectivity between a specific Pseudo IMSI and the Kᵢ_{_}index. Here, it is assumed that a method for generating a Pseudo IMSI is the same as the method described above. For example, the Pseudo IMSI is generated based on the IMSI and the Master Key Ki, or the IMSI, the Master Key Ki and the randomvalue.

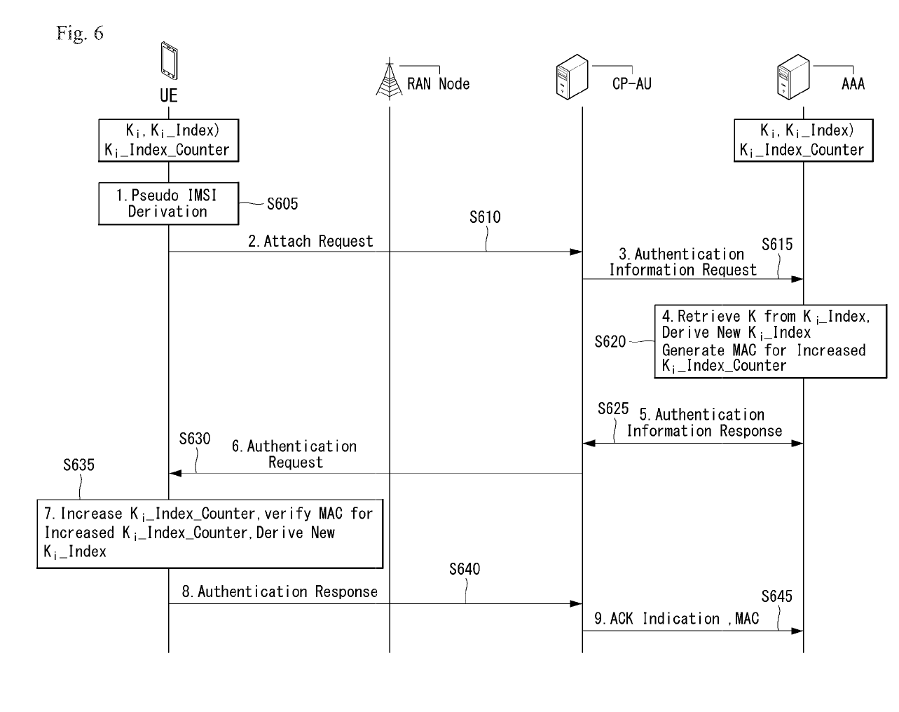

In an embodiment of the present invention, in order to remove the connectivity between the Pseudo IMSI and the Kᵢ_{_}index, a UE and a subscriber information storage (i.e., Authentication, Authorization, and Accounting (AAA)) may use the Message Authentication Code (MAC) with respect to the Kᵢ_{_}index_Counter in relation to the change of the Kᵢ_{_}index. The detailed content for it will be described with reference to FIG. 6.

FIG. 6 illustrates an example of an initial access procedure of a UE using a Pseudo IMSI to which the present invention may be applied. FIG. 6 is only shown for the convenience of description, but does not limit the scope of the present invention.

Referring to FIG. 6, the case is assumed that a UE and an AAA use the MAC with respect to the Kᵢ_{_}index_Counter for the synchronization of the Kᵢ_{_}index_Counter that is increased whenever Kᵢ_{_}index is changed, in relation to the Kᵢ_{_}index linked with the Pseudo IMSI.

In this case, the UE and the AAA possess the Kᵢ (i.e., Master Key Kᵢ), the Kᵢ_{_}index and the Kᵢ_{_}index_Counter values initially (i.e., know in advance). Herein, the Kᵢ_{_}index_Counter is a variable that represents the information for the number of changes.

In step S605, the UE generates a Pseudo IMSI. In this case, the Pseudo IMSI may be used for protecting a permanent identifier, that is, an IMSI of the UE, and may be generated according to the method described above. In other words, the UE may generate a Pseudo IMSI using an IMSI and a Kᵢ (randomvalue may be additionally used).

After the UE generates the Pseudo IMSI, in step S610, the UE transmits an Attach Request message to a network authentication entity (i.e., 5G network authentication entity (Control Plane Authentication Function; CP-AU)) or a first authentication entity. In this case, the Attach Request message includes the generated Pseudo IMSI and the Kᵢ_{_}index.

After the CP-AU receives the Attach Request message, in step S615, the CP-AU transfers the Pseudo IMSI and the Kᵢ_{_}index to the AAA (or a second authentication entity) using an Authentication Information Request message.

After the AAA receives the Authentication Information Request message, in step S620, the AAA identifies the Kᵢ using the Kᵢ_{_}index. In this case, since the Kᵢ_{_}index is changed whenever using the Pseudo IMSI, through an initial Kᵢ_{_}index maintained by the UE and the HSS, the Master Key Kᵢ of a specific UE may be identified. Later, through the changed Kᵢ_{_}index, the connectivity between the Master Key of the corresponding UE and the Kᵢ_{_}index may be removed. In other words, the AAA maintains the connectivity information of the Master Key of a specific UE, an initial Kᵢ_{_}index (i.e., Kᵢ_{_}index initially possessed by the UE and the AAA) and the Kᵢ_{_}index changed corresponding to the Kᵢ_{_}index.

After the AAA identifies the Kᵢ from the Kᵢ_{_}index, the AAA identifies the IMSI through the Pseudo IMSI using the identified K, and generates a New Kᵢ_{_}index. In order to generate the New Kᵢ_{_}index, the AAA may use the Kᵢ_{_}index_Counter. In this case, the New Kᵢ_{_}index may be generated according to Equation 1 below.

New Kᵢ_{_}index=f(Kᵢ _{_}index, Kᵢ_{_}index_Counter) [Equation 1]

In Equation 1, Function f means a function for generating the New Kᵢ_{_}index. Herein, the Function f may mean an arbitrary function without any special limitation. In this case, the Kᵢ_{_}index_Counter may be set as an arbitrary value (e.g., 0) initially. In addition, whenever the New Kᵢ_{_}index is generated, the value indicated by the Kᵢ_{_}index_Counter increases by a predetermined value (e.g., 1).

In addition, in order to verify (or identify) the Kᵢ_{_}index_Counter which is increased between the UE and the AAA, the AAA may generate a Message Authentication Code (MAC) for the newly generated Kᵢ_{_}index_Counter (i.e., increased Kᵢ_{_}index_Counter). In this case, in order to generate the MAC (i.e., in order to encode), a Message Authentication Key (MAK) may be used. In addition, the MAK may also be used for decrypting (i.e., encoding) the generated MAC. Herein, the MAK may be generated by the AAA according to Equation 2 below.

MAK=KDF (Kᵢ, RAND, etc) [Equation 2]

In Equation 2, Function KDF (Key Derivation Function) means a function for calculating a key in the cryptography scheme. In addition, the Kᵢ means a Master Key Kᵢ possessed by the UE and the AAA, and RAND means a RAND value used for authentication (e.g., RAND value used by the AAA in order to generate an authentication vector).

Later, in step S625, the AAA transmits (or transfers) an Authentication Information Response message including an authentication vector for UE authentication, an indicator for increase of the Kᵢ_{_}index_Counter (i.e., an indicator indicating (or specifying) increase of the Kᵢ_{_}index_Counter for the UE) and the MAC value for the increased Kᵢ_{_}index_Counter to the CP-AU (i.e., the network authentication entity). In this case, since the UE increases the Kᵢ_{_}index_Counter value whenever the UE uses the Pseudo IMSI, the indicator for the increase of the Kᵢ_{_}index_Counter may be optional information.

After the CP-AU receives the Authentication Information Response message, in step S630, the CP-AU extracts an Authentication Token (AUTN) and/or the RAND from the authentication vector. Later, the CP-AU transmits an Authentication Request message including the extracted AUTN, the extracted RAND, the indicator for the increase of the Kᵢ_{_}index_Counter and the MAC value for the increased Kᵢ_{_}index_Counter to the UE.

In step S635, the UE that receives the Authentication Request message increases its own Kᵢ_{_}index_Counter value according to the indicator for the increase of the Kᵢ_{_}index_Counter (or as the UE generates the Pseudo IMSI). Later, the UE may calculate the MAC for the increased Kᵢ_{_}index_Counter, and may determine (or verify) whether the calculated MAC value is identical to the received MAC value. Herein, the key used for verifying the MAC for Kᵢ_{_}index_Counter by the UE is the same as the key used in step S620, that is, the MAK. That is, the UE may generate the MAK according to Equation 2, and may perform authentication for the MAC using the generated MAK.

When the UE identifies that the MAC value for the received Kᵢ_{_}index_Counter and the calculated MAC value are identical, the UE generates a New Kᵢ_{_}index based on the increased Kᵢ_{_}index_Counter. In this case, the UE may generate the New Kᵢ_{_}index according to Equation 1.

Later, in step S640, the UE transmits an Authentication Response message including information such as a RES (Response) used for user authentication by a network, an ACK indicator for increase of the Kᵢ_{_}index_Counter, the MAC value for increased Kᵢ_{_}index_Counter, and so on. Herein, the ACK indicator for increase of the Kᵢ_{_}index_Counter may be an indicator indicating that increase of the Kᵢ_{_}index_Counter is performed by the UE. In addition, since the AAA may identify whether the Kᵢ_{_}index_Counter is increased through the MAC value for the increased Kᵢ_{_}index_Counter, the ACK indicator for increase of the Kᵢ_{_}index_Counter may be optional information.

Finally, in step S645, the CP-AU transfers the ACK indicator for increase of the Kᵢ_{_}index_Counter and the MAC value for the increased Kᵢ_{_}index_Counter to the AAA. Through this, the AAA may determine whether the increase of the Kᵢ_{_}index_Counter is successfully performed by the UE.

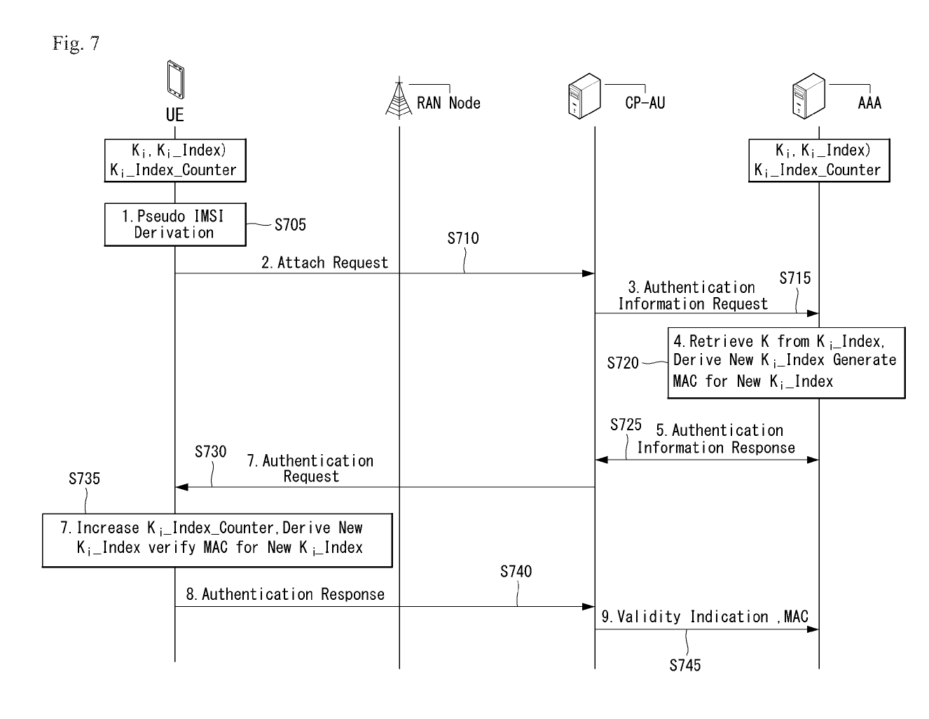

In addition, in another embodiment of the present invention, in order to remove the connectivity between the Pseudo IMSI and the Kᵢ_{_}index, a UE and an AAA may use the MAC changed whenever using the Pseudo IMSI, that is, the MAC for a New Kᵢ_{_}index. The detailed description for it will be described with reference to FIG. 7.

FIG. 7 illustrates another example of an initial access procedure of a UE using a Pseudo IMSI to which the present invention may be applied. FIG. 7 is only shown for the convenience of description, but does not limit the scope of the present invention.

Referring to FIG. 7, the case is assumed that a UE and an AAA use the MAC with respect to the New Kᵢ_{_}index for the synchronization of the Kᵢ_{_}index_Counter that is increased whenever the Kᵢ_{_}index is changed, in relation to the Kᵢ_{_}index linked with the Pseudo IMSI.

In this case, the UE and the AAA possess the Kᵢ (i.e., Master Key Kᵢ), the Kᵢ_{_}index and the Kᵢ_{_}index_Counter values initially (i.e., know in advance). Herein, the Kᵢ_{_}index_Counter is a variable that represents the information for the number of changes.

In this case, the operations in step S705, step 710 and step 715 are the same as the operations in step S605, step S610 and step S615. Accordingly, the description for step S705, step 710 and step 715 will be omitted.

After the AAA receives the Authentication Information Request message, in step S720, the AAA identifies Kᵢ using the Kᵢ_{_}index. In this case, since the Kᵢ_{_}index is changed whenever using the Pseudo IMSI, through an initial Kᵢ_{_}index maintained by the UE and the HSS, the Master Key Kᵢ of a specific UE may be identified. Later, through the changed Kᵢ_{_}index (i.e., the New Kᵢ_{_}index), the connectivity between the Master Key of the corresponding UE and the Kᵢ_{_}index may be removed. In other words, the AAA maintains the connectivity information of the Master Key of a specific UE, an initial Kᵢ_{_}index (i.e., Kᵢ_{_}index initially possessed by the UE and the AAA) and Kᵢ_{_}index changed corresponding to Kᵢ_{_}index.

After the AAA identifies the Kᵢ from the Kᵢ_{_}index, the AAA identifies the IMSI through the Pseudo IMSI using the identified K, and generates a New Kᵢ_{_}index. In order to generate the New Kᵢ_{_}index, the AAA may use the Kᵢ_{_}index_Counter. In this case, the New Kᵢ_{_}index may be generated according to Equation 3 below.

New Kᵢ_{_}index=f(Kᵢ_{_}index, Kᵢ_{_}index_Counter) [Equation 3]

In Equation 3, Function f means a function for generating the New Kᵢ_{_}index. Herein, the Function f may mean an arbitrary function without any special limitation. In this case, the Kᵢ_{_}index_Counter may be set as an arbitrary value (e.g., 0) initially. In addition, whenever the New Kᵢ_{_}index is generated, the value indicated by the Kᵢ_{_}index_Counter increases by a predetermined value (e.g., 1).

In addition, In order to verify (or identify) the Kᵢ_{_}index_Counter which is increased between the UE and the AAA, the AAA may generate a Message Authentication Code (MAC) for the newly generated Kᵢ_{_}index (i.e., the New Kᵢ_{_}index). In this case, in order to generate the MAC (i.e., in order to encode), a Message Authentication Key (MAK) may be used. In addition, the MAK may also be used for decrypting (i.e., encoding) the generated MAC. Herein, the MAK may be generated by the AAA according to Equation 4 below.

MAK=KDF (Kᵢ, RAND, etc) [Equation 4]

In Equation 4, Function KDF (Key Derivation Function) means a function for calculating a key in the cryptography scheme. In addition, Kᵢ means a Master Key Kᵢ possessed by the UE and the AAA, and RAND means a RAND value used for authentication (e.g., RAND value used by the AAA in order to generate an authentication vector).

Later, in step S725, the AAA transmits (or transfers) an Authentication Information Response message including an authentication vector for UE authentication, an indicator for increase of the Kᵢ_{_}index_Counter (i.e., an indicator indicating (or specifying) increase of the Kᵢ_{_}index_Counter for the UE) and the MAC value for the New Kᵢ_{_}index generated in step S720. In this case, since the UE increases the Kᵢ_{_}index_Counter value whenever the UE uses the Pseudo IMSI, the indicator for the increase of the Kᵢ_{_}index_Counter may be optional information.

After the CP-AU receives the Authentication Information Response message, in step S730, the CP-AU extracts an Authentication Token (AUTN) and/or the RAND from the authentication vector. Later, the CP-AU transmits an Authentication Request message including the extracted AUTN, the extracted RAND, the indicator for the increase of the Kᵢ_{_}index_Counter and the MAC value for the New Kᵢ_{_}index to the UE.

In step S735, the UE that receives the Authentication Request message increases its own Kᵢ_{_}index_Counter value according to the indicator for the increase of the Kᵢ_{_}index_Counter (or as the UE generates the Pseudo IMSI). Later, the UE may generate New Kᵢ_{_}index according to Equation 3 using the increased Kᵢ_{_}index_Counter. In addition, the UE may calculate the MAC for the generated New Kᵢ_{_}index, and may determine (or verify) whether the calculated MAC value is identical to the received MAC value. Herein, the key used for verifying the MAC for the New Kᵢ_{_}index by the UE is the same as the key used in step S720, that is, the MAK. That is, the UE may generate the MAK using Kᵢ and/or RAND, etc. according to Equation 4, and may perform authentication for the MAC using the generated MAK.

As the UE identifies that the MAC value for the received New Kᵢ_{_}index and the calculated MAC value are identical, the UE may determine that the increased Kᵢ_{_}index_Counter value used for generating the New Kᵢ_{_}index is synchronized with the AAA.

Later, in step S740, the UE transmits an Authentication Response message including information such as a RES (Response) used for user authentication by a network, an ACK indicator (validity indication) for the New Kᵢ_{_}index, the MAC value for the New Kᵢ_{_}index, and so on. Herein, the ACK indicator for the New Kᵢ_{_}index may be an indicator specifying (indicating) the indication for the New Kᵢ_{_}index which is generated by the UE. In addition, since the AAA may identify whether the Kᵢ_{_}index_Counter is synchronized through the MAC value for the New Kᵢ_{_}index which is received, the ACK indicator for the New Kᵢ_{_}index may be optional information.

Finally, in step S745, the CP-AU transfers the ACK indicator for the New Kᵢ_{_}index and the MAC value for the New Kᵢ_{_}index the AAA. Through this, the AAA may determine whether the increase of the Kᵢ_{_}index_Counter is successfully performed by the UE. That is, as the AAA identifies whether the MAC value for the received New Kᵢ_{_}index and the MAC value for the New Kᵢ_{_}index generated in step S20 are identical, the AAA may determine that the increased Kᵢ_{_}index_Counter used for generating the New Kᵢ_{_}index by the UE is synchronized with its own Kᵢ_{_}index_Counter.

As described above, when the Pseudo IMSI is used, the exposure of the IMSI may be prevented through the method of using the information shared between a UE and an HSS while not transmitting the IMSI as a clear-text. This is because the IMSI and the Long Term Shared Key K (i.e., Kᵢ) are the values possessed only between the UE and the HSS.

In addition, in the various embodiments of the present invention, the Pseudo IMSI may be generated by using MSIN and Kᵢ only, saving MCC∥MNC that constructs the PLMN ID for MCC∥MNCμMSIN that are elements of the conventional IMSI. In other words, in the procedures for a network (initial) access described above, the Pseudo IMSI defined by MCC∥MNCμf(MSIN, (truncate: 15 bits) K) may be used.

Or, the format of Kᵢ_{_}index used together with the Pseudo IMSI in the procedures for a network (initial) access described above may be constructed as MCC∥MNC∥Kᵢ_{_}index Number (about 9 bits). In this case, the New Kᵢ_{_}index may be defined as MCC|MNC|f(Kᵢ_{_}index Number, Kᵢ_{_}index_Counter).

In the case that the Pseudo IMSI is generated using an IMSI, Master Key Ki, and/or randomvalue as described above, it may be preferable that the New Kᵢ_{_}index is configured as MCC|MNC|f(Kᵢ_{_}index Number, Kᵢ_{_}index_Counter).

On the contrary, in the case that the Pseudo IMSI is defined as MCC|MNC|f(MSIN, (truncate: 15 bits) K), it may be preferable that the New Kᵢ_{_}index is configured as MCC|MNC|f(Kᵢ_{_}index Number, Kᵢ_{_}index_Counter).

General Apparatus to which the Present Invention may be Applied

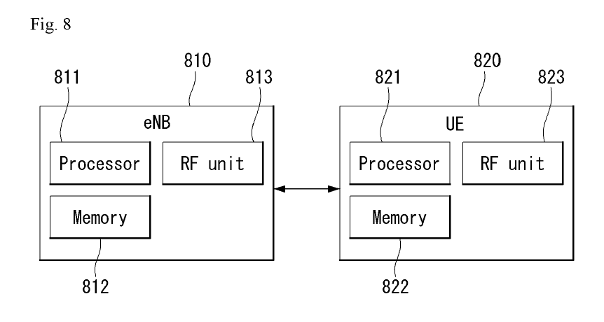

FIG. 8 illustrates a block diagram of a wireless communication apparatus according to an embodiment of the present invention. Referring to FIG. 8, the wireless communication system includes a BS (eNB) 810 and a plurality of terminals (UEs) 820 located within the region of the BS 810.

The BS 810 includes a processor 811, a memory 812 and a radio frequency (RF) unit 813. The processor 811 implements the functions, processes and/or methods proposed in FIGS. 1 to 7 above. The layers of wireless interface protocol may be implemented by the processor 811. The memory 812 is connected to the processor 811, and stores various types of information for driving the processor 811. The RF unit 813 is connected to the processor 811, and transmits and/or receives radio signals.

The terminal 820 includes a processor 821, a memory 822 and a RF unit 823. The processor 821 implements the functions, processes and/or methods proposed in FIGS. 1 to 7 above. The layers of wireless interface protocol may be implemented by the processor 821. The memory 822 is connected to the processor 821, and stores various types of information for driving the processor 821. The RF unit 823 is connected to the processor 821, and transmits and/or receives radio signals.

The memories 812 and 822 may be located interior or exterior of the processors 811 and 821, and may be connected to the processors 811 and 821 with well known means. In addition, the BS 810 and/or the terminal 820 may have a single antenna or multiple antennas.

The embodiments described so far are those of the elements and technical features being coupled in a predetermined form. So far as there is not any apparent mention, each of the elements and technical features should be considered to be selective. Each of the elements and technical features may be embodied without being coupled with other elements or technical features. In addition, it is also possible to construct the embodiments of the present invention by coupling a part of the elements and/or technical features. The order of operations described in the embodiments of the present invention may be changed. A part of elements or technical features in an embodiment may be included in another embodiment, or may be replaced by the elements and technical features that correspond to other embodiment. It is apparent to construct embodiment by combining claims that do not have explicit reference relation in the following claims, or to include the claims in a new claim set by an amendment after application.

The embodiments of the present invention may be implemented by various means, for example, hardware, firmware, software and the combination thereof. In the case of the hardware, an embodiment of the present invention may be implemented by one or more application specific integrated circuits (ASICs), digital signal processors (DSPs), digital signal processing devices (DSPDs), programmable logic devices (PLDs), field programmable gate arrays (FPGAs), a processor, a controller, a micro controller, a micro processor, and the like.

In the case of the implementation by the firmware or the software, an embodiment of the present invention may be implemented in a form such as a module, a procedure, a function, and so on that performs the functions or operations described so far. Software codes may be stored in the memory, and driven by the processor. The memory may be located interior or exterior to the processor, and may exchange data with the processor with various known means.

It will be understood to those skilled in the art that various modifications and variations can be made without departing from the essential features of the inventions. Therefore, the detailed description is not limited to the embodiments described above, but should be considered as examples. The scope of the present invention should be determined by reasonable interpretation of the attached claims, and all modification within the scope of equivalence should be included in the scope of the present invention.

Although the method for performing initial access procedure based on authentication in a wireless communication system of the present invention is described mainly for the example applied to 3GPP LTE/LTE-A system, it is also possible to be applied to various wireless communication system as well as 3GPP LTE/LTE-A system.

According to an embodiment of the present invention, a network initial access is performed using the Pseudo IMSI, and accordingly, a user equipment may perform the initial access without exposing its own permanent identifier (e.g., IMSI).

In addition, according to an embodiment of the present invention, the index for Master Key K (e.g., Kᵢ) changed whenever the Pseudo IMSI is generated is used, it may be prevented the exposure of a user by an association between the Pseudo IMSI and a user equipment.

The effects of the present invention are not limited to the above-described effects and other effects which are not described herein will become apparent to those skilled in the art from the description.

What is claimed is:

1. A method for performing initial access procedure based on authentication in a wireless communication system, the method performed by a user equipment comprising:
generating a pseudo permanent identifier based on a permanent identifier of the user equipment;
transmitting, to a first authentication entity, a first message including the pseudo permanent identifier and an index of a specification authentication key;
receiving, from the first authentication entity, a second message including a first Message Authentication Code (MAC) for at least one a first new authentication key generated by a second authentication entity or a first increased counter at the second authentication entity for a specific authentication counter; and
in response to the first MAC, transmitting, to the first authentication entity, a third message including a second MAC for at least one a second new authentication key generated by the user equipment or a second increased counter at the user equipment for the specific authentication counter;
wherein the specification authentication key and the specific authentication counter are predefined between the user equipment and the second authentication entity.

2. The method of claim 1, wherein the first new authentication key is generated by using the first increased counter and the specification authentication key that is identified based on the pseudo permanent identifier; and
wherein the second new authentication key is generated by using the second increased counter and the specification authentication key.

3. The method of claim 2, wherein the specific authentication counter of the second authentication entity is increased by generating the first new authentication key; and
wherein the specific authentication of the user equipment is increased by generating the pseudo permanent identifier.

4. The method of claim 3, wherein the first MAC and the second MAC are generated by using an authentication key, and
wherein the authentication key is based on at least one the specific authentication key or a random value generated by the second authentication entity.

5. The method of claim 4, wherein the random value is generated by using an authentication vector.

6. The method of claim 3, wherein the second message further includes an indication for increasing the specific authentication counter of the user equipment.

7. The method of claim 6, wherein the third message further includes an indication for representing increase of the specific authentication counter of the user equipment.

8. The method of claim 1, further comprising prior to transmitting the third message:
in response to the received second message, calculating the second MAC based on the second increased counter and the second new authentication key; and
determining whether a value for the received first MAC is identical to a value for the calculated second MAC.

9. A user equipment for performing initial access procedure based on authentication in a wireless communication system, the user equipment comprising:
a transmission/reception unit for transmitting and receiving a radio signal, and
a processor functionally coupled to the transmission/reception unit,
wherein the processor is configured to control to:
generate a pseudo permanent identifier based on a permanent identifier of the user equipment;
transmit, to a first authentication entity, a first message including the pseudo permanent identifier and an index of a specification authentication key;
receive, from the first authentication entity, a second message including a first Message Authentication Code (MAC) for at least one a first new authentication key generated by a second authentication entity or a first increased counter at the second authentication entity for a specific authentication counter; and
in response to the first MAC, transmit, to the first authentication entity, a third message including a second MAC for at least one a second new authentication key generated by the user equipment or a second increased counter at the user equipment for the specific authentication counter;
wherein the specification authentication key and the specific authentication counter are predefined between the user equipment and the second authentication entity.

10. The user equipment of claim 9, wherein the first new authentication key is generated by using the first increased counter and the specification authentication key that is identified based on the pseudo permanent identifier; and
wherein the second new authentication key is generated by using the second increased counter and the specification authentication key.

11. The user equipment of claim 10, wherein the specific authentication counter of the second authentication entity is increased by generating the first new authentication key; and
wherein the specific authentication of the user equipment is increased by generating the pseudo permanent identifier.

12. The user equipment of claim 11, wherein the first MAC and the second MAC are generated by using an authentication key, and
wherein the authentication key is based on at least one the specific authentication key or a random value generated by the second authentication entity.

13. The user equipment of claim 12, wherein the random value is generated by using an authentication vector.

14. The user equipment of claim 11, wherein the second message further includes an indication for increasing the specific authentication counter of the user equipment.

15. The user equipment of claim 14, wherein the third message further includes an indication for representing increase of the specific authentication counter of the user equipment.
